(19) United States
(12) Patent Application Publication
(10) Pub. No.: US 2021/0102543 A1
(43) Pub. Date: Apr. 8, 2021

(54) Apparatus for Electrically Powered Water Feature

(71) Applicant: UNI-POWA CORPORATION LTD., London (GB)

(72) Inventors: Simon Reeves-Jackson, Weston-super-Mare (GB); Simon Wigglesworth, London (GB); Alan Lawrence, Kintbury (GB); James Stiff, Newbury (GB); Petrus Hendrik Bezuidenhout, De Rust (ZA); Paul Dack, Ripley (GB)

(21) Appl. No.: 17/123,072

(22) Filed: Dec. 15, 2020

Related U.S. Application Data
(63) Continuation-in-part of application No. PCT/GB2019/051698, filed on Jun. 18, 2019.

(30) Foreign Application Priority Data
Jun. 18, 2018 (GB) 1809958.0
Mar. 29, 2019 (GB) 1904476.7

(51) Int. Cl. F04D 13/08; H02J 7/00; F04D 13/02; F04D 29/40

(52) U.S. Cl. CPC F04D 13/08; H02J 7/0063; F04D 13/068; F04D 29/406; F04D 13/024

(57) ABSTRACT

Apparatus for an electrically powered fluid feature comprises a unit including a fluid pump and a rechargeable power source arranged to provide power to the pump for operation of the fluid feature. The power source may be rechargeable via electrical contacts. The unit may comprise upper and lower housing portions that are separable to allow cleaning, replacement or recycling of components. The unit may be removably installed in a reservoir, which is supported within a container by adjustable supports.

### RELATED APPLICATIONS

This application is a continuation-in-part of International Application No. PCT/GB2019/051698 filed on Jun. 18, 2019, which claims the benefit of United Kingdom (Great Britain) Patent Application No. 1809958.0 filed on Jun. 18, 2018, and of United Kingdom (Great Britain) Patent Application No. 1904476.7 filed on Mar. 29, 2019. The disclosures of these applications are expressly incorporated herein by reference in their entireties.

### FIELD OF THE INVENTION

The present invention relates to apparatus for an electrically powered water (or other liquid or fluid) feature.

### BACKGROUND

Conventional electrically powered water features, particularly for indoor or garden use, generally fall into two categories: mains-powered, or solar-powered. Mains-powered water features suffer from the inconvenience of requiring a mains cable connection, with associated safety issues. Solar-powered water features may be completely self-contained but require strong sunlight to operate effectively; this renders them unsuitable for use indoors, or in countries where strong sunlight is not often available. An example of a solar-powered water feature invented by the present inventor is disclosed in WO-A-2005/011874 (Smart Solar).

In solar-powered water features, it is known to provide a battery charged by power from solar cells; this helps to even out the power supplied to a pump of the water feature, so that the pump can continue to operate for a short while when the sun is not shining. However, this does not overcome the requirements for use indoors or in countries or conditions where the sunlight is too weak.

GB-A-2522414 discloses apparatus for an electrically-powered water or liquid feature, including a wirelessly rechargeable power source.

### SUMMARY

According to an aspect of the present invention, there is provided apparatus for an electrically powered fluid feature, comprising a unit including a housing containing a pump and a rechargeable power source for the pump. The apparatus may include a contact power receiver for charging the power source. The power receiver may be positioned in a housing of the apparatus. For example, the power receiver may be positioned in an upper portion of the housing.

The contact power receiver may have waterproof contacts. The contact power receiver may comprise a magnetic connector.

The housing may comprise a lower portion that is liquid permeable to allow liquid to enter an inlet of the pump. The lower portion may comprise a filter. The lower portion may be removably attachable or attached to the upper portion to form a unit or common housing.

The upper portion may be separated from the lower portion, for example for charging of the power source in the upper portion and/or for cleaning of the lower portion. The upper and/or lower portion(s) may include one or more sealed electrical components, such as the power source and/or a circuit board. The electrical component(s) may be located in one or more compartments and sealed therein, for example by pouring and setting a liquid sealant therein, inserting a pre-formed seal, ultrasonic welding of the compartment, or a combination thereof.

The unit may be controllable by a user interface, such as a remote control or a control provided on the unit.

The pump may be removably electrically connected or connectable to the power source, for example to allow the pump to be replaced or upgraded separately from the remainder of the unit. There may be a water- or liquid-proof electrical connector between the power source and the pump.

The pump may be mechanically removable from the upper portion and/or from the lower portion, for example to facilitate cleaning, repair and/or replacement.

The unit is preferably portable, and removable from its associated water feature for recharging or storage.

The unit may be removably installed in a feature including a reservoir. There may be provided apparatus for enabling this removable installation. The apparatus may be arranged for converting a conventional receptacle, such as a pot or planter, to a water feature. The apparatus may seal a drainage hole of the pot or planter and support the unit at the required height within the receptacle. Alternatively, the apparatus may attach to the rim of the pot or planter. The apparatus may include a surround that supports decorative features, such as pebbles, around and above the unit within the receptacle.

There may be provided an upper tier portion positionable above the reservoir and removably connectable to an output of the pump, such that fluid output by the pump passes into the upper tier portion and thence cascades from the upper tier portion into the fluid reservoir.

Other aspects and optional features of the invention are defined in the claims.

### BRIEF DESCRIPTION OF THE DRAWINGS

There now follows, by way of example only, a detailed description of preferred embodiments of the present invention, with reference to the Figures identified below.

FIGS. 1A to 1F show an electrically powered fountain unit in a first embodiment of the present invention, in which:

FIG. 1A is a perspective view from above;

FIG. 1B is a side elevation view;

FIG. 1C is a plan view from above;

FIG. 1D is a plan view from below;

FIG. 1E is a perspective view from below of an upper portion of the unit; and

FIG. 1F is a plan view of the upper portion from below.

FIGS. 2A to 2E show an upper portion of an electrically powered fountain unit in a second embodiment, in which:

FIG. 2A is a side elevation;

FIG. 2B is a plan view from below;

FIG. 2C is a cross section in the plane C-C marked in FIG. 2A, including a magnified detail D;

FIG. 2D is a perspective view from below; and

FIG. 2E is an exploded perspective view from above.

FIGS. 3A to 3D show a lower portion of the electrically powered fountain unit in the second embodiment, in which:

FIG. 3A is a plan view from above;

FIG. 3B is a side elevation;

FIG. 3C is a perspective view from above; and

FIG. 3D is a cross-section in the plane A-A of FIG. 3B.

FIGS. 4A to 4D show a variant of the lower portion of the electrically powered fountain unit of the second embodiment, in which:

FIG. 4A is a plan view from above;

FIG. 4B is side elevation;

FIG. 4C is a perspective view from above; and

FIG. 4D is a cross-section in the plane B-B of FIG. 4B.

FIG. 5 is a diagram of the upper portion of the first embodiment placed on a charging base.

FIG. 6 is a diagram of a variant of the arrangement of FIG. 5.

FIGS. 7A to 7E show the unit of the second embodiment placed in a charging container:

FIG. 7A is a plan view from above;

FIG. 7B is side elevation;

FIG. 7C is a perspective view from above;

FIG. 7D is a cross-section in the plane EE-EE of FIG. 7B; and

FIG. 7E is an exploded perspective view.

FIGS. 8A to 8C show the unit of the second embodiment located in a water feature, in which:

FIG. 8A is a perspective view from above;

FIG. 8B is a side view; and

FIG. 8C is an exploded perspective view from above.

FIGS. 9A to 9E show apparatus for mounting a unit according to an embodiment in a receptacle, in which:

FIG. 9A is an exploded perspective view of the apparatus, with the receptacle cut away;

FIG. 9B shows a range of extension rods for use with the apparatus;

FIGS. 9C and 9D are perspective views of a tightening disc and bottom plate, respectively from above and below; and

FIG. 9E is a perspective view of the unit being removably placed in a recess of an upper portion of the apparatus.

FIG. 10 shows an exploded perspective view a variant of the apparatus of FIGS. 9A to 9E.

FIG. 11 shows a side view of another variant for mounting the unit with a plurality of tiers of receptacles, show in cut-away view.

FIG. 12 is an exploded perspective view of an upper portion of a unit in a third embodiment.

FIGS. 13A to 13D show a unit of the third embodiment placed in a charging unit, in which:

FIG. 13A is a side view;

FIG. 13B is a side view orthogonal to FIG. 13A;

FIG. 13C is a cross-section in the plane G-G of FIG. 13B; and

FIG. 13D shows detail H of FIG. 13C.

FIGS. 14A to 14C show an alternative mounting apparatus for mounting a unit according to an embodiment in a receptacle, in which:

FIG. 14A is a perspective view of the alternative mounting apparatus;

FIG. 14B is a side view of the alternative mounting apparatus, with the unit and receptacle shown in dotted outline; and

FIG. 14C is an exploded perspective view from below of the alternative mounting apparatus, with a close-up view of one of the hooks and ties thereof.

FIGS. 15A to 15C show another alternative mounting apparatus for mounting a unit according to an embodiment in a receptacle, in which:

FIG. 15A is an exploded perspective view of the mounting apparatus, part of which is shown in cross-section;

FIG. 15B is an elevation of the mounting apparatus, part of which is shown in cross-section;

FIG. 15C is a perspective view of a tier portion of the apparatus; and

FIG. 15D is a perspective view of a tube portion of the apparatus.

FIG. 16 is a schematic diagram of a system incorporating the unit of any one of the embodiments.

FIG. 17 is a diagram showing the operation of a unit in an embodiment.

### DETAILED DESCRIPTION OF THE EMBODIMENTS

General Description

Embodiments of the invention comprise a pump 2 for pumping water (or other liquid) as part of the function of the water feature, for example for pumping water through a nozzle 3 in a fountain, or pumping water to a higher level in a cascade. The pump 2 is electrically powered, and includes a motor, a liquid inlet and a liquid outlet.

Power for the pump 2 is provided by a rechargeable power source 1, such as a one or more cells, batteries or capacitors. The capacity of the rechargeable power source 1 is sufficient to power the pump 2 for a length of time appropriate for the water feature, without requiring additional power from another source, such as a mains or solar power supply. Preferably, the rechargeable power source 1 is the sole power source for the pump 2.

Preferably, the pump 2 and rechargeable power source 1 are combined in a common housing so as to provide a single, compact module or unit 20 that may be supplied as a self-contained water feature or as a component for integration into a water feature. The size and/or shape of the module or unit may be chosen to suit the application. In a specific example, the dimensions of the module or unit are 120×83 mm. The unit is preferably light and easily portable, weighing for example between 0.1 and 1 Kg, and preferably between 200 and 500 g.

The module or unit 20 may be submersible in water or other liquid, for example in a reservoir such as a pond, fountain reservoir or birdbath, to provide a water feature such as a fountain, cascade, or bubbler. In some embodiments, the unit could be designed for other types of water or liquid feature, such as for example a rain effect feature using oil rather than water. Alternatively, the unit 20 may be arranged to pump gas, such as air, from a gas inlet, for example to create a bubble effect or as an aerator for a fish tank.

The module or unit 20 may be designed to sink so as to rest on a floor of the reservoir or may be sufficiently buoyant to float. In the latter case, the unit 20 may include one or more attachment points for attachment of an anchor, for example by cords, and/or for attachment of a cord or other means for retrieving the unit 20 from the water feature. The unit 20 may include one or more buoyancy components, such as buoyancy chambers, that are either permanently installed within the unit to provide buoyancy, or may be removably installed so as to allow the unit 20 to be buoyant or not, depending on the required application.

The power source 1 may be rechargeable by contactless or wireless charging, for example by inductive charging in proximity to a contactless or wireless power transmitter 5 connected to a source of mains power, as in the first and second embodiments described below.

Alternatively, the power source 1 may be rechargeable by a contact connection, for example as in the third embodiment described below. Alternatively, the power source 1 may be rechargeable by a combination or selection of contact and wireless connections.

Specific embodiments of the invention are described in detail below. Similar features between different embodiments are described using the same reference numerals. In this description ‘upper’, ‘lower’, ‘top’, bottom’, ‘vertical’ and similar terms are defined with reference to the normal orientation of the module or unit when the pump 2 is in use, for example with the nozzle 3 projecting upwards.

Unit Construction

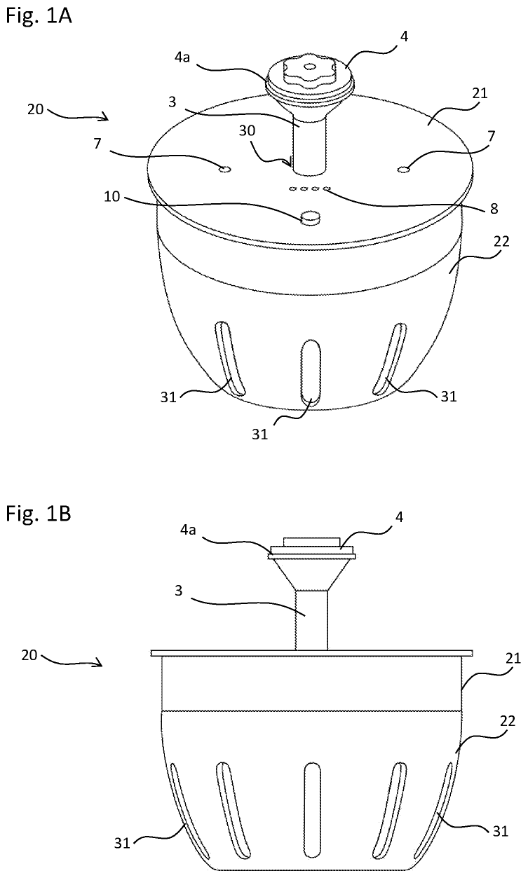

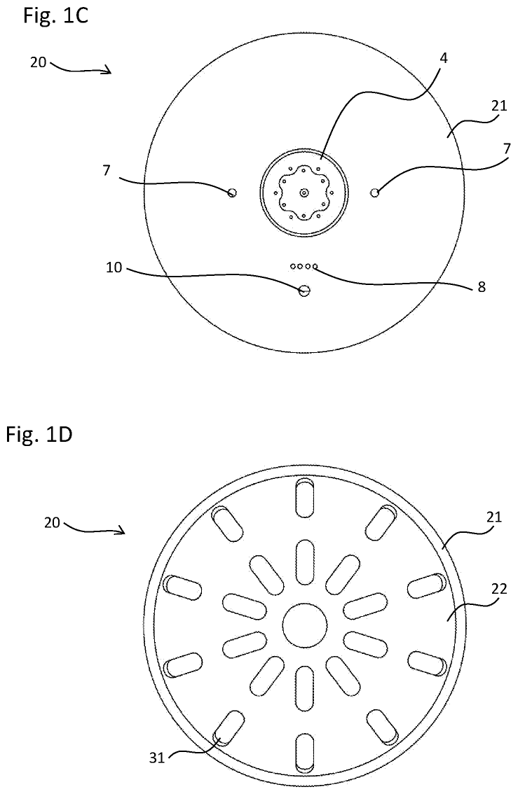

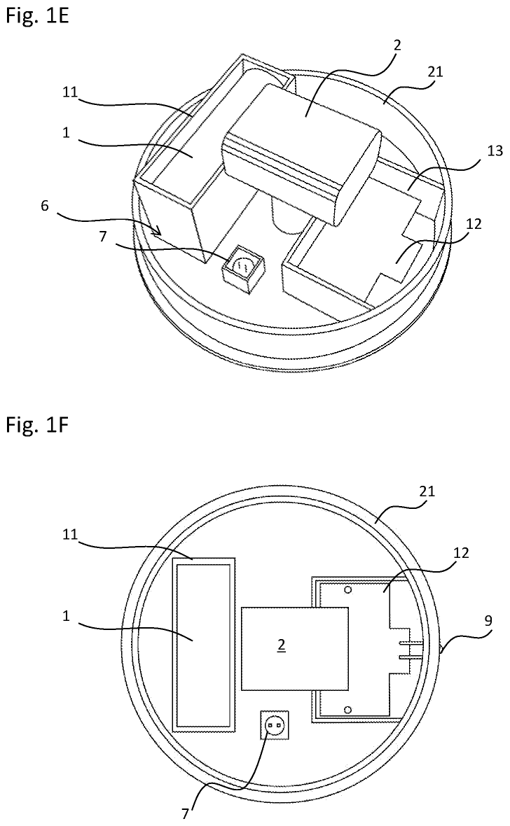

The first embodiment is illustrated in FIGS. 1A to 1F. In this embodiment, the common housing comprises an upper portion 21 and a lower portion 22 that are removably attachable together, for example by a screw, bayonet or clip fitting, to form a module or unit.

The upper portion 21 generally has the form of a lid for attachment to the lower portion 22, and has a generally flat planar upper surface having an outlet aperture 30 connected to an outlet of the pump 2. A nozzle 3 may fit into or through the outlet aperture 30, so as to project generally vertically or perpendicularly from the upper surface.

The nozzle 3 may have a head 4 that has one or more outlets for providing a water effect. For example, the head 4 may be a spray head for providing a fountain effect. The head 4 may be moved (e.g. rotated) by the passage of liquid therethrough, for example to provide a moving fountain or spray effect.

The nozzle 3 may be removable from the outlet aperture 30 so that interchangeable nozzles 3 with different heads 4 may be used for different water effects. Alternatively or additionally, the head 4 may be removable from the nozzle 3 so that interchangeable heads 4 may be used with the same nozzle 3. Instead of the head 4, a tube may be attached to the nozzle 3 or directly to the outlet 30 to convey the liquid to an outlet (e.g. a higher level in a cascade). In some applications, such as a bubbler, no attachment is used and the liquid issues directly from the outlet 30.

Preferably, the nozzle 3 and/or the head 4 may be usable to lift and carry the unit 20 (or at least the upper portion 21). To this end, the nozzle 3 and/or the head 4 are preferably removably attached to the upper portion 21 by a connection that cannot easily be pulled apart when the nozzle 3 and/or the head 4 are used as a handle, such as a bayonet, screw, click or clip fitting. The head 4 may be wider in at least one radial direction than the nozzle 3, so that the head 4 can be used as a handle. The head 4 may for example have a projecting rim 4a.

As shown in FIGS. 1E and 1F, the upper portion 21 contains or includes the power source 1, pump 2, a wireless power receiver 6 and a controller 12. The power source 1 may comprise one or more rechargeable cells or batteries, such as lithium batteries.

The wireless power receiver 6 may be an inductive charging coil or other means for wirelessly receiving energy (e.g. capacitive, magnetic and/or magnetodynamic coupling) and providing the received energy to recharge the power source 1.

The pump 2 may be removably attached to the power source 1, with cables, connectors and/or contacts provided on each to establish an electrical connection when the pump 2 and power source 1 are connected together. Preferably, the electrical connection is made waterproof, for example by one or more seals. The removable attachment may be by means of one or more clips, detents and the like, by a magnetic connection or by an interference fit.

The controller 12 may comprise a circuit board for controlling operation of the pump 2 and/or other components, such as one or more light sources 7, a power indicator 8, and/or a charging indicator 9. The light sources 7 may comprise LED lights arranged to illuminate water or other liquid emerging from the head 4.

The power indicator 8 indicates the charging level of the power source 1, and may comprise a plurality of LEDs, the number of which are lit indicating the charging level, or a single variable color LED to indicate the charging level (e.g. red, amber or green). The charging indicator 9 indicates whether the power source 1 is being charged. The charging indicator 9 is located on the side of the upper portion 21 so as to be visible during charging, as described further below.

A photoreceptor 10 may be provided on the upper surface of the upper portion 21, so as to detect an ambient light level and provide a corresponding output to the controller 12, for example to control the operation of the pump 2 and/or other components according to the ambient light level. In one example, the pump 2 may be switched off when the ambient light level is low. Alternatively, the light sources 7 may be switched on when the ambient light level is low. In another example, the photoreceptor 10 may be used to detect a charging condition, as described further below.

The power source 1 may be contained within a power source compartment 11 attached to or provided on the inner surface of the upper portion 21. The power source 1 may be sealed within the compartment 11 by a seal, which may either be formed by pouring and setting a liquid sealant into the compartment 11, or by fitting a pre-formed seal within the compartment 11.

In this embodiment, the wireless power receiver 6 is located within the compartment 11, under the power source 1. Hence, the wireless power receiver 6 is proximate the surface of the upper portion 21, for close coupling to a wireless power transmitter 5.

The controller 12 may be contained within a controller compartment 13 attached to or provided on the inner surface of the upper portion 21. The controller 12 may be sealed within the compartment 13 by a seal, which may either be formed by pouring and setting a liquid sealant into the compartment 13, or by fitting a pre-formed seal within the compartment 13.

The pump 2 may be removably attached to the upper portion 21, for example to allow repair or replacement of the pump 2. Alternatively, the pump may be permanently attached to the upper portion 21. The pump 2 may be supported by a part of the lower portion 22, for example by abutment or engagement within the inner surface of the bottom wall of the lower portion 22.

The lower portion 22 has one on more inlet apertures 31 which allow water or other liquid to enter the lower portion 22 and pass into an inlet of the pump 2. One or more filters may be provided in the lower portion 22, for example in the inlet apertures 31 or between the inlet apertures 31 and the inlet of the pump 2. The filter(s) may comprise nylon mesh or similar material. The filter(s) may be cleaned by removing the lower portion 22 from the upper portion 21. Alternatively, the filter(s) may be removably fitted around the outer surface of the lower portion 22 so that the filter(s) can be changed without separating the upper and lower portions 21, 22.

Alternatively, an inlet tube may be attached to the inlet of the pump, and the lower portion 22 may be dispensed with altogether. The inlet tube may include a filter.

One or more floats or buoyancy chambers (not shown) may be installed in the upper portion 21 or lower portion, or may be fitted between the upper and lower portions 21, 22. The buoyancy chambers may be permanently or removably installed so as to allow the unit 20 to be buoyant or not, depending on the required application. The buoyancy chambers may comprise hollow or foam-filled chambers and may be shaped to fit a space within the unit 20.

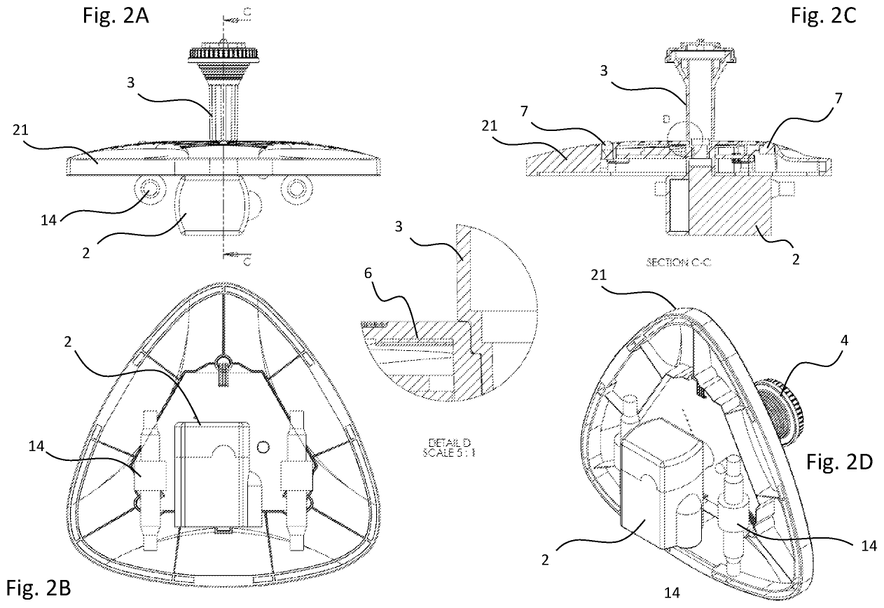

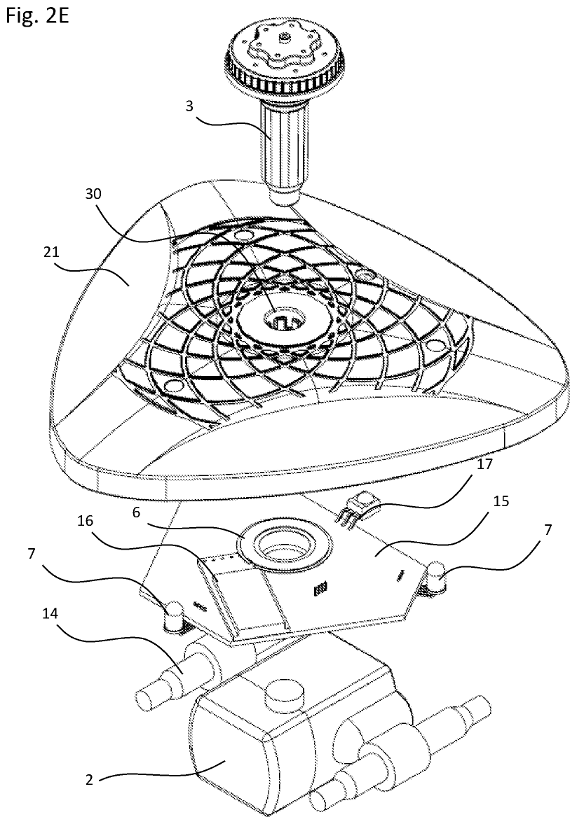

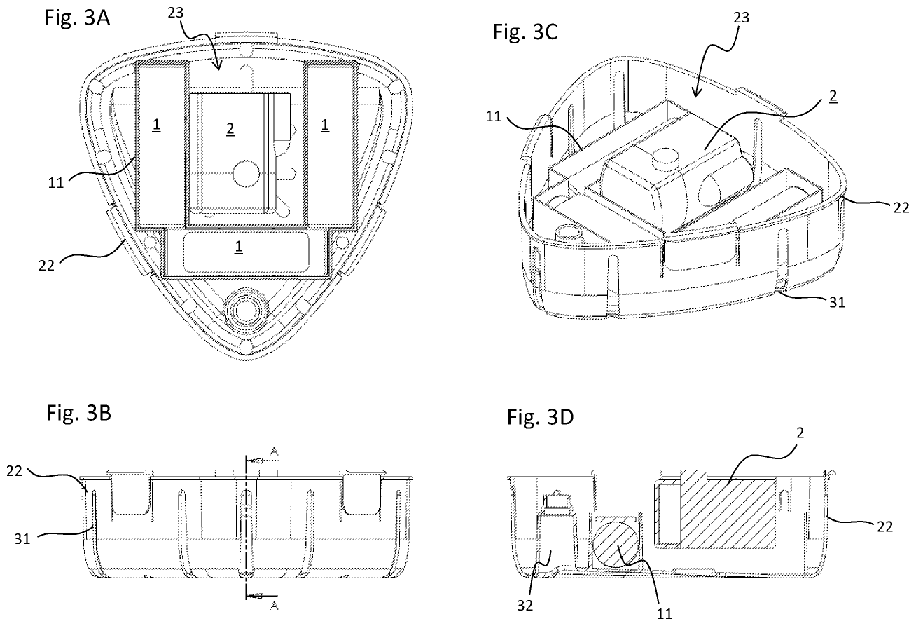

A second embodiment is illustrated in FIGS. 2A to 3D. Similarly to the first embodiment, the common housing or unit 20 comprises an upper portion 21, as shown in FIGS. 2A to 2D and a lower portion 22, as shown in FIGS. 3A to 3D. However, in the second embodiment the power source 1 and associated power source compartments 11 are not included in the upper portion 21, but are instead located in the lower portion 22. The power source 1 is connected to electrical components in the upper portion 21 and/or directly or indirectly to the pump 2 through cables (not shown, for clarity) connected together by waterproof cable connectors 14, which may for example be plug and socket connectors or magnetic connectors.

The lower portion 22 and the upper portion 21 may be removably held together, preferably by user-operable means such as resilient clips in the lower portion 22 that engage a rim in the upper portion 21, as shown in FIGS. 3A to 3D. Alternatively or additionally, screws and/or other means may be used.

The provision of the power source 1 in the lower portion 22 allows the power source 1 to be easily removed, for example for recycling or disposal, without the need to replace the components in the upper portion 21. This is advantageous where the power source comprises rechargeable batteries containing compounds that may be harmful to the environment.

In the second embodiment, the pump 2 is mounted close to the upper portion 21, for example at substantially the same level as the power source 1 and/or within a space between batteries or cells of the power source 1. This provides a compact arrangement, which reduces the overall height of the unit 20 and brings the pump 2 close to the outlet aperture 30 so as to reduce the height through which the fluid must be pumped and thereby increase pump outlet pressure from the unit 20.

In this embodiment, the power source 1 comprises three rechargeable batteries arranged in respective compartments 11, at right angles to each other to form a U-shape. The pump 2 is located in a space or chamber 23 within the U-shape. Alternatively, depending on the shape and size of the pump 2, the compartments 11 may be arranged in a triangular shape, or there may be four compartments 11 arranged in a rectangular shape, preferably with the pump 2 arranged in the space or chamber 23 within that shape. A plurality of rechargeable batteries may be stacked in a vertical direction in each battery compartment 11, or in separate compartments.

The pump 2 is preferably removably attached to the outlet aperture 30 so that it may be removed for cleaning, servicing or replacement. The pump 2 may be supported within the lower portion 22, but is preferably not permanently attached thereto.

The lower portion 22 includes inlet apertures 31 which allow liquid to flow into the lower portion 22 and thence into an inlet of the pump 2.

As shown in detail D of FIG. 2C, the lower end of the nozzle 3 fits sealingly into the outlet aperture 30, for example by means of an interference fit. Optionally, a seal may be provided between the outlet aperture 30 and the nozzle 3, the seal being carried by either or both of these parts. The lower end of the nozzle 3 has a reduced diameter so as to fit within the outlet aperture 30, and preferably has a stepped profile arranged to fit against a corresponding stepped profile within the outlet aperture 30.

The lower portion 22 includes a nozzle holder 32 into which the lower end of the nozzle 3 fits, when removed from the outlet aperture 30 for storage.

As shown in FIG. 2E, the electronic components of the upper portion 21 are mounted on a printed circuit board (PCB) 15 having an aperture through which the pump 2 outlet fits. The wireless power receiver 6 is arranged around this aperture, for example as an annulus. The wireless power receiver 6 is arranged close to the upper surface of the upper portion 21, for example between the PCB 15 and a housing of the upper portion 21, or even molded into the housing.

The electronic components include light emitting diodes (LEDs) 7, a Bluetooth® module 16 and an infrared (IR) receiver 17.

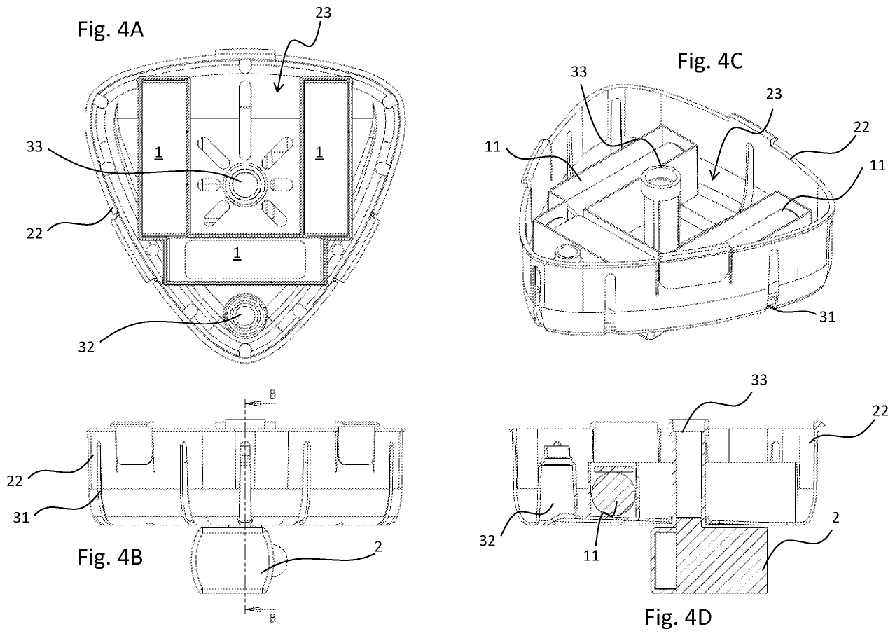

FIGS. 4A to 4D show a variant of the lower portion 22, in which the pump 2 is located below the lower portion 22 and is removably connected to a duct 33 which passes through the lower portion 22 and is removably connected to the outlet aperture 30 when the upper and lower portions 21, 22 are connected together. This arrangement is less compact, and gives a lower pump pressure at the outlet aperture 30, but facilitates removal and cleaning of the pump 2. This arrangement is also suitable where there is insufficient space for the pump 2 in the lower portion 22, or where a narrower unit 20 is required in order to fit in the water feature. The duct 33 may be integrally formed with the lower portion 22, for example as part of the same molding.

In another variant, the pump 2 may be located above the power source 1 in the lower portion 22. This arrangement may be suitable where the unit 20 is required to be narrow, and has the advantage of bringing the pump 2 closer to the outlet aperture 30.

Charging

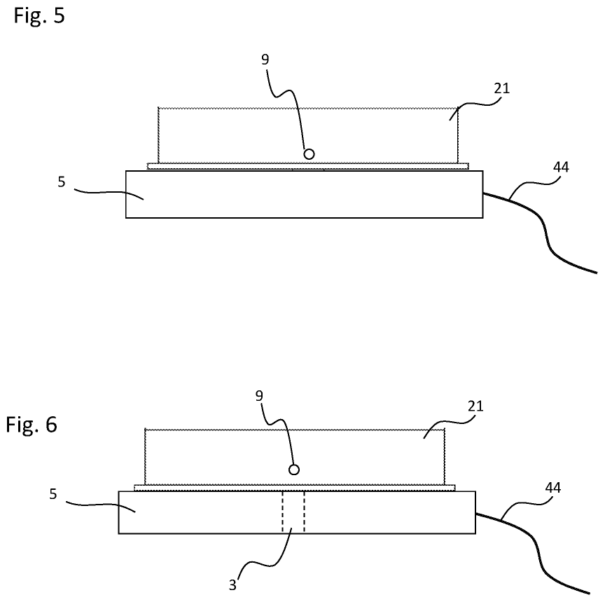

A charging arrangement for the first embodiment is illustrated in FIGS. 5 and 6. The upper portion 21 may be placed in proximity to the power transmitter 5 for charging. The power transmitter 5 comprises a wireless charging transmitter, such as an inductive coil, for providing energy wirelessly to the power receiver 6. Power may be supplied to the wireless charging transmitter by a cable 44 to an electrical source such as a mains or low voltage (e.g. USB) supply.

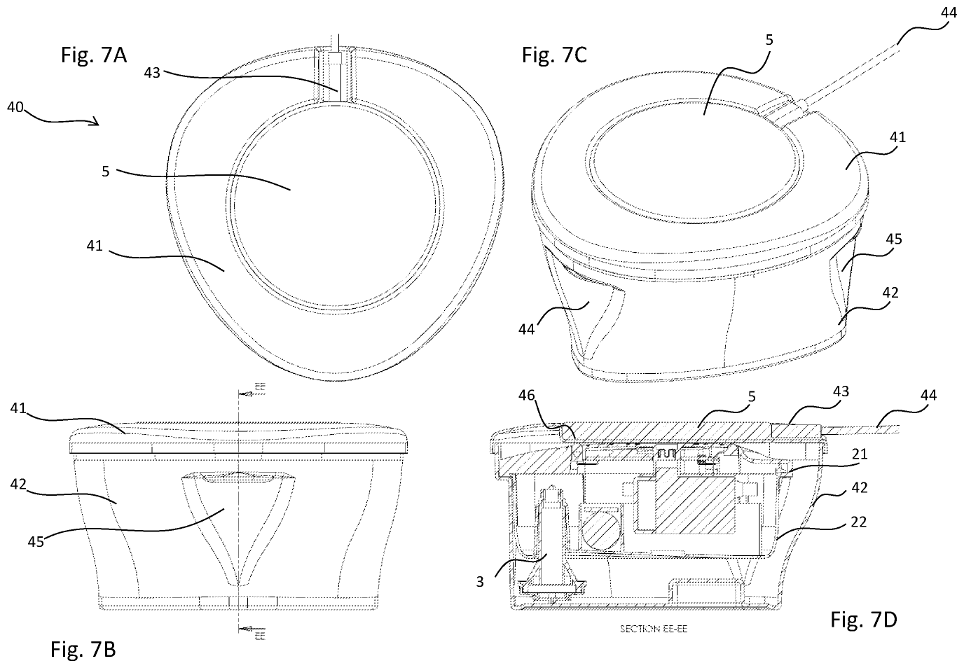

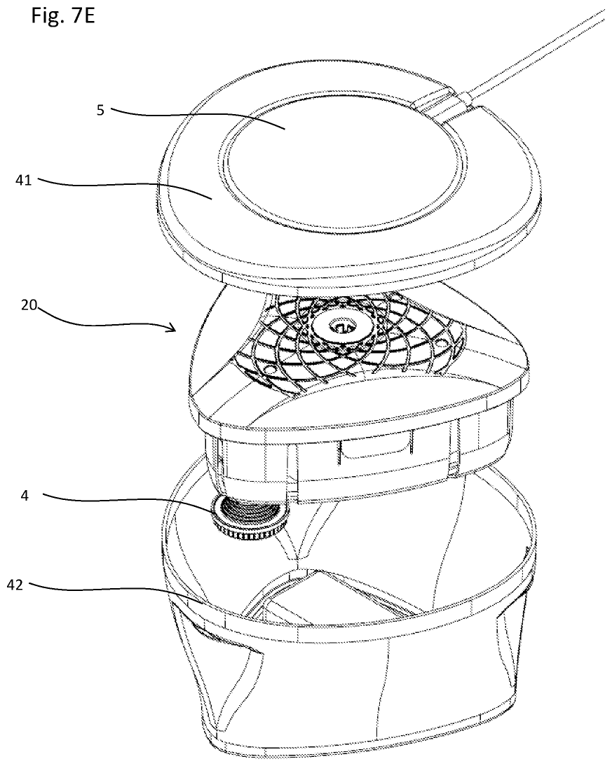

In the first embodiment, the wireless power transmitter 5 comprises a flat pad, mat or base onto which the upper portion 21 is placed upside down, so that the flat upper surface thereof rests on the wireless power transmitter 5. To enable this, the nozzle 3 may be removed from the upper portion 21 before charging, as shown in FIG. 7. Alternatively, as shown in FIG. 6, the wireless power transmitter 5 may include a recess or aperture into which the nozzle 3 fits, thereby positively locating the upper portion 21 on the power transmitter 5, preferably in an optimum position for charging, such that the charging transmitter is aligned with the power receiver 6. The head 4 may need to be removed from the nozzle 3 prior to charging, so that the nozzle 3 fits within the recess or aperture in the power transmitter 5.

In another alternative, the nozzle 3 may be removed prior to charging, and the power transmitter 5 may include a projection that fits within or engages the outlet aperture 30 in the upper surface of the upper portion 21, thereby positively locating the upper portion 21 on the power transmitter 5.

When the upper portion 21 is placed upside down on the power transmitter 5, the power indicator 8 is obscured, being located on the upper surface of the upper portion 21. However, the charging indicator 9, being located on a side of the upper portion 21, is not obscured so that a user can confirm that wireless charging is taking place.

The photoreceptor 10 may also be obscured during charging, which may provide an indication to the controller 12 that the upper portion 21 is in a position for charging.

In alternative embodiments, the power transmitter 5 may be shaped so that the upper portion 21 fits therein or thereon. For example, the power transmitter 5 may have a raised periphery within which the upper portion 21 fits, or conversely the upper portion 21 may have a recess into which the power transmitter 5 fits. The upper surface of the upper portion 21 may not be flat or planar but may be curved, and a corresponding upper surface of the power transmitter may be shaped to conform to the curve.

The upper portion 21 may be separated from, or attached to the lower portion 22 for charging.

The wireless power receiver 6 may be located in any appropriate location within the housing of the unit 20, either in the upper portion 21 or the lower portion 22. Advantageously, the location of the wireless power receiver 6 in the housing, either in the upper portion 21 or lower portion 22, provides the user with a convenient and waterproof method of charging the module or unit 20.

Charging Container

FIGS. 7A to 7E illustrate a charging arrangement for the second embodiment, in which the unit 20, when not in use, is removed from the water feature and is housed in a container 40 comprising a base 42 and a top 41. The top 41 has a recess 46 in which the power transmitter 5 is removably located. The unit 20 is located within the container 40 such that the upper portion 21 is proximate to the top 41, and hence to the power transmitter 5 when located therein. The cable 44 is removably connected to the power transmitter 5 by a plug 43, such as a mini-USB plug connected to a corresponding socket in the power transmitter 5.

The container 40 therefore provides the combined functions of storing the unit 20 when not in use, retaining any fluid that leaks from the unit 20, and aligning the power transmitter 5 with the power receiver 6. The container may have a plurality of indents 45 at the corners thereof, to facilitate carrying.

As shown in FIG. 7D, the nozzle 3 may be located in the nozzle holder 32 and thereby extends into a space in the container base 42, which conveniently allows the nozzle 3 to be stored together with the unit 20 in the container. Alternatively, the nozzle 3 may be stored in a space within the container, but not connected to the unit 20. There may be provided a plurality of interchangeable nozzles 3 with different heads 4, each storable or stored as described above.

The lower portion 22 may be designed to facilitate draining of liquid out of the unit 20, for example through the inlet aperture(s) 31. For example, the internal bottom surface of the lower portion 22 may include channels or other features that slope towards the inlet apertures 31.

Water Feature Installation

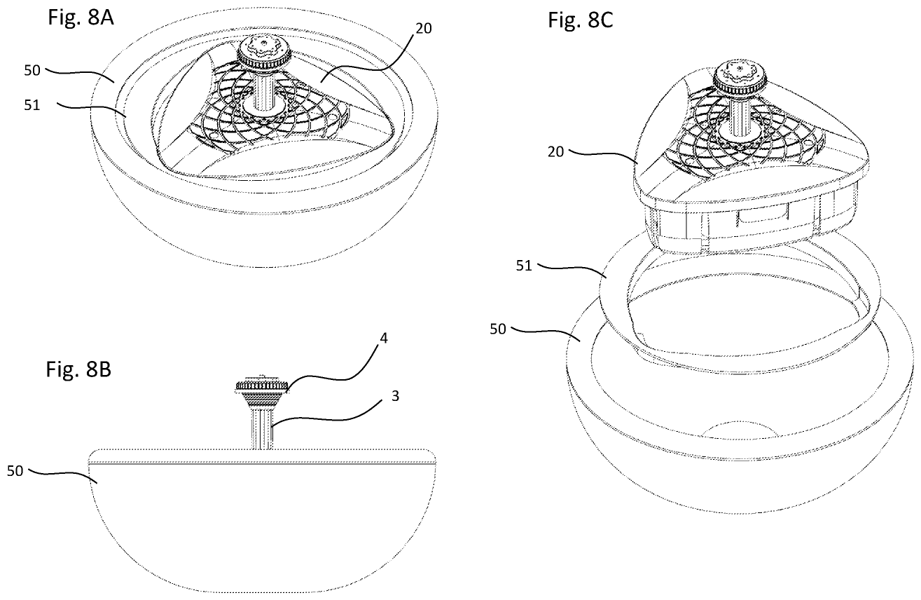

FIGS. 8A to 8C show an embodiment of the installation of the unit 20 of the second embodiment, or another embodiment, in an example water feature, comprising a fluid reservoir 50 and an adapter or fitting 51 for fitting the unit 20 into the reservoir 50. Different adapters 51 may allow the unit 20 to be fitted within different water features.

In this example, the reservoir 50 has the form of a bowl and the adapter 51 has the form of a ring that fits within the rim of the bowl and has an interior shape adapted to contact and support the unit 20 within the reservoir 50. Spaces between the adapter 51 and the unit 20 allow fluid which flows into the inlet apertures 31 and is then pumped through the nozzle 3 to fall back into the reservoir 50. The spaces may also allow the unit 20 to be easily removed from the adapter 51, for example by the user's fingers.

The unit 20 may be held within the adapter 51 by gravity, or by a locking arrangement such as one or more clips, click fittings, twist-and-lock fitting or other fitting. The adapter 51 may be permanently or temporarily attached to the reservoir 50, or may be integrated with the reservoir 50.

Alternatively, where the unit 20 is buoyant, the unit 20 may be allowed to float within the reservoir, either freely or secured in position by one or more attachments, such as anchors or tethers secured between attachment points on the unit 20 and attachment points on the reservoir 50. In this case, the reservoir may be a body of water such as a pond or lake, or a pre-existing water feature such as a birdbath or trough.

Alternative water features may have alternative forms of reservoir and/or additional features. For example, the unit 20 may be located remote from the reservoir 50, with a conduit running from the reservoir to the pump inlet.

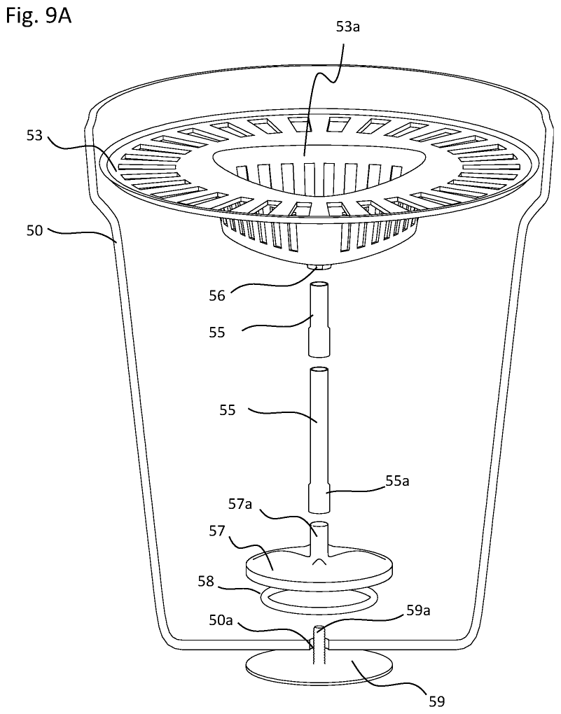

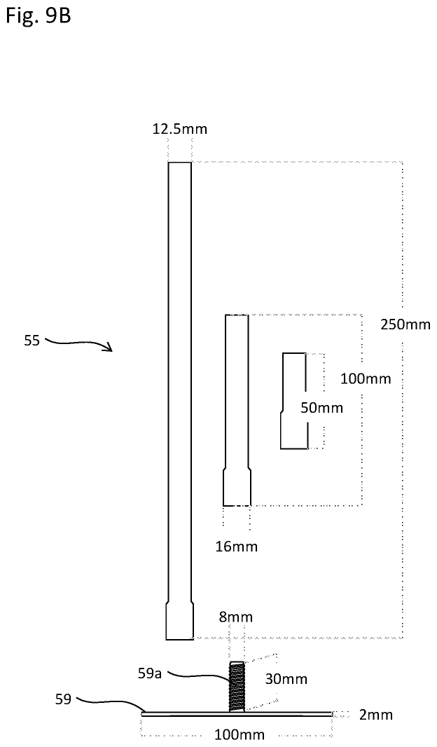

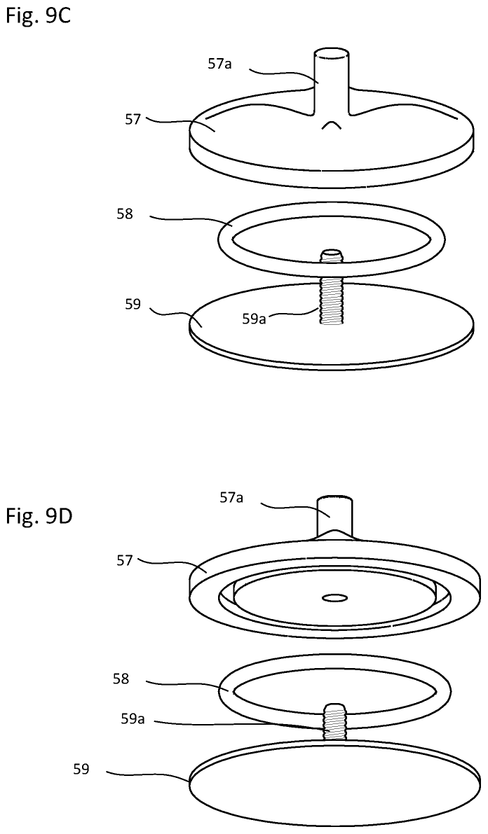

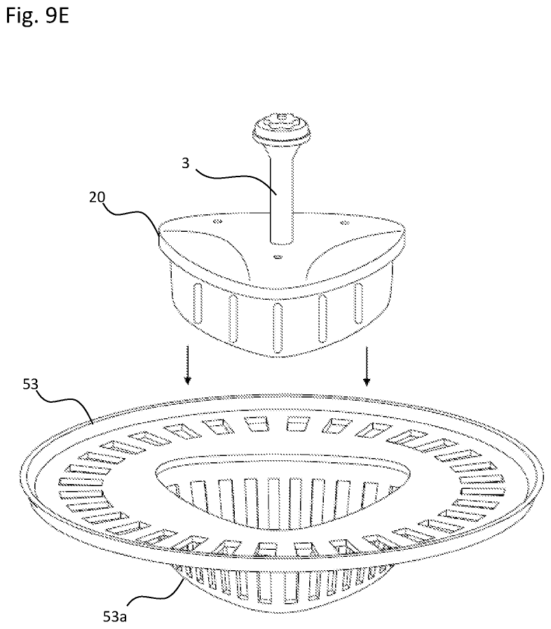

FIGS. 9A to 9E show alternative apparatus for the installation of the unit 20 in a reservoir 50 comprising a pot or planter, having a drainage hole 50a in the bottom. This type of pot or planter is widely available in a variety of shapes, sizes and styles, for growing and keeping plants, and is typically made of ceramic, plastic or fiberglass material. The apparatus comprises a platform 53 including a recessed portion 53a for receiving the unit 20. The recessed portion 53q is perforated to allow fluid to flow into the unit 20, and the outer part of the platform 53 is perforated to allow fluid dispensed by the unit 20 to flow through the platform 53 into a lower part of the pot 50.

The outer part of the platform 53, surrounding or extending beyond the recessed portion 53a, may be used to support decorative material such as pebbles, gravel, plants etc. The perimeter of the platform 53 is preferably arranged to fit the inner perimeter of the pot 50, preferably so as to contact the inner perimeter of the pot 50 for greater stability, or at least to be in close proximity to the inner perimeter, and may be circular, square or rectangular depending on the shape of the pot 50. The outer part of the platform 53 may be planar and horizontal, or may be contoured or stepped to support decorative material at different heights. Alternatively, the outer part of the platform 53 may be molded for decorative effect, having for example the appearance of pebbles or other decorative material.

A threaded rod 59a is attached (e.g. by welding) to a head, stop or bottom plate 59, both of which may be made of steel. The bottom plate 59 is placed on the underside of the pot 50 with the threaded rod 59a projecting through the drainage hole 50a so that the bottom plate 59 abuts the external underside of the pot 50. The bottom plate 59 is preferably sufficiently thin as to not destabilize the pot 2, but extends radially beyond the drainage hole 50a so that it cannot pass through the drainage hole 50a and to provide a stable base for the threaded rod 59a. The head, stop or bottom plate 59 may be perforated or consist of a plurality of radially extending fingers, and need not be a solid plate.

A clamping member, such as a tightening disc 57, is screwed onto the threaded rod 59a from within the pot 50, so that the bottom of the pot 50 is clamped between the bottom plate 59 and the tightening disc 57. The tightening disc 57 may have projections or wings on its upper surface, to aid tightening by hand.

The clamping of the bottom of the pot 50 compresses a seal 58 around the drainage hole 50a. The seal 58 may be an O-ring seal carried in a groove of the tightening disc 57 as shown in FIG. 9D. The seal 58 may alternatively or additionally be carried by the bottom plate 59. If necessary, the threaded connection between the tightening disc 57 and the threaded rod 59a may be made waterproof using a PTFE tape or coating.

The upper surface of the tightening disc 57 has an upwardly projecting, preferably central portion 57a onto which the lower end of an extension rod 55 is then removably fitted, for example by means of a flared joint 55a. A further extension rod 55 having a flared joint 55a may then be fitted on top of the first extension rod 55. The platform 53 is then attached to the upper end of the extension rod 55, for example by means of an interference fit in a cylindrical wall or recess 56 in the bottom of the platform 53.

The extension rod(s) 55 are preferably of hollow tubular steel construction, to provide sufficient strength and rigidity to support the platform 53, the unit 20 and decorative material placed on the platform 53.

The installation is then completed by removably placing the unit 20 into the recessed portion 53a, as shown in FIG. 9E, placing any desired material on the platform 53 surrounding the recessed portion 53a, and filling the pot 50 with fluid above the level of the bottom of the recessed portion 53a so that the fluid may be pumped by the unit 20. The installation converts a standard pot or planter 20 into a water feature that may be customized by the use of decorative material and is not constrained by access to mains electricity.

The height of the platform 53 above the bottom plate 59 may be adjusted by selection of the length of the extension rod 55 from a range of different lengths, such as 250 mm, 100 mm and 20 mm as shown in FIG. 9B, or by the use of more than one extension rod 55 fitted in series.

In an alternative embodiment, upwardly projecting portion 57a may be elongated and may fit directly into the recess 56 in the bottom of the platform 53 without the need for any extension rod 55, although the extension rod(s) 55 may be fitted onto the elongated upwardly projecting portion 57a if required for additional height.

In another alternative embodiment, the lower end of the extension rod 55 may be fixed directly to the bottom plate 59 and may have a threaded section that performs a similar function to the threaded rod 59a. In that case, the tightening disc 57 is fitted over the end of the extension rod 55 and screwed onto the threaded section.

A kit of parts may be provided for installation of the unit 20 into pots 50 of different heights and/or horizontal cross-sections, the kit comprising in one embodiment: one or more platforms 53 of different shaped or sized perimeters or of different decorative appearances, one of more extension rods 55 of the same or different lengths; the bottom plate 59, the tightening disc 57 and the seal 58. The components may be selected as appropriate to the embodiment.

In an alternative embodiment, a telescopic rod may be used instead of extension rods 55. The telescopic rod may be lockable at the desired length, for example using a twist action between different rod sections thereof.

Alternative forms of platform 53 may be used. For example, the platform 53 may be flat, without the recessed portion 53a, and the unit 20 may be removably fixed to, or may rest on the upper surface of the platform 53. In this case, the fluid level must be above the level of the platform 53, in order to reach the inlet apertures 31 of the unit 20.

In another alternative, the platform 53 may be designed to float on the surface of the fluid or to abut the sides of the pot 50, so that no extension rod 55 is required, although this arrangement is less suitable for carrying decorative material such as pebbles. In that alternative, the drainage hole 50a (if present) may be sealed by the clamping arrangement described above, or another sealing arrangement separate from the platform 53.

In another alternative in which the reservoir 50 has no drainage hole 50a, the tightening disc 57 may be replaced by a support plate that is fixed directly to the bottom of the reservoir 50, either permanently with adhesive or temporarily, for example with a suction cup.

In yet another alternative, the platform 53 may be omitted and the bottom of the unit 20 may have a recess that is removably fitted directly onto the upper end of the extension rod 55. This alternative may be used where no decorative material surrounding the unit 20 is required.

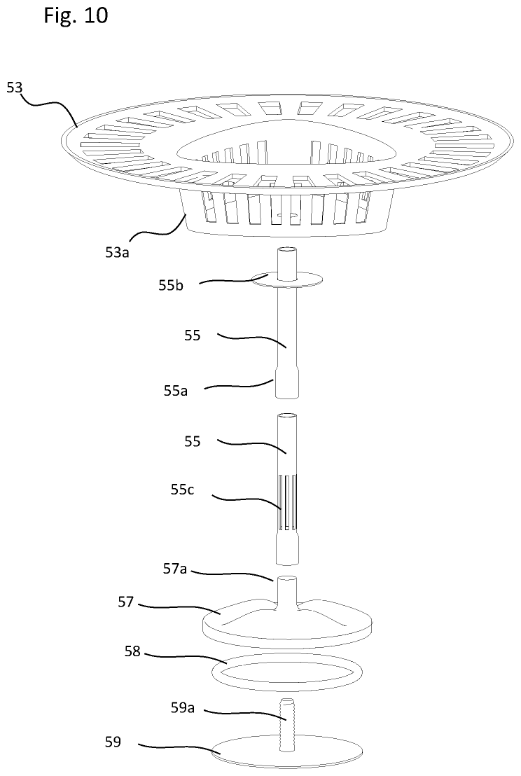

A variant is shown in FIG. 10, in which the lowermost one of the extension rods 55 has a fluid inlet 55c, and the uppermost one of the extension rods 55 has flange 55b around the upper end thereof, for supporting the platform 53. The upper end passes through an aperture in the bottom of the platform 53 and is connected directly to the inlet of the pump 2. The extension rods 55 are hollow and provide a fluid passage from the fluid inlet 55c to the pump 2, allowing the pump 2 to pump fluid when the fluid level falls below the bottom of the platform 53. Alternatively, an inlet tube may be connected to the inlet of the pump and may pass through the extension rods to the level of the fluid inlet 55c, so that the joints 55a need not be fluid tight.

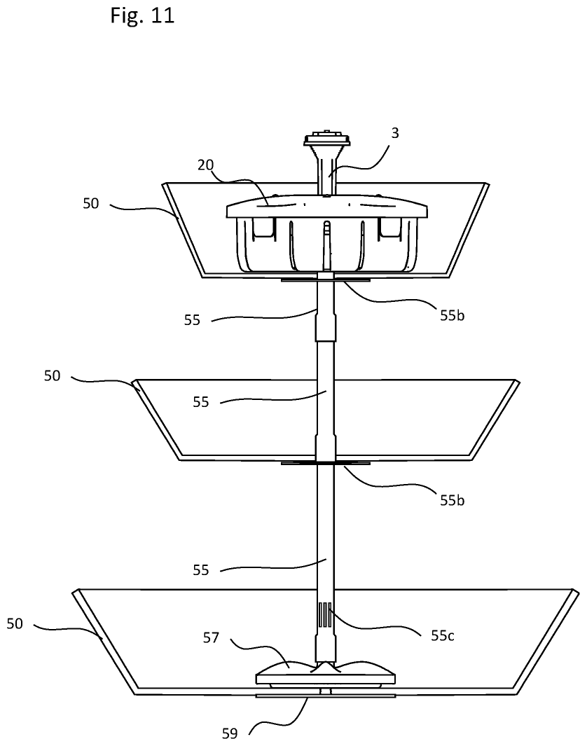

Another variant is shown in FIG. 11, in which a plurality of fluid receptacles or reservoirs 50 each having drainage holes 50a are provided in tiers, for example to create a cascade effect. The drainage hole of the lowermost receptacle 50 is clamped between the bottom plate 59 and the tightening plate 57, while the upper receptacles 50 are supported on flanges 55b of respective extension rods 55 which pass through the respective drainage hole 50a. The flanges 55b may have seals on their upper surfaces, to reduce leakage through the drainage hole.

In this variant, there is no platform 53 but the upper end of the uppermost extension rod 55 is fitted through the drainage hole 50a of the uppermost receptacle 50, and connected directly to the inlet of the pump 2. The lowermost extension rod 55 may have a fluid inlet 55c, allowing fluid to be drawn from the lowermost receptacle 50 up to the pump 2 in the unit 20. Fluid pumped out of the nozzle 3 may then cascade down the tier of receptacles 50.

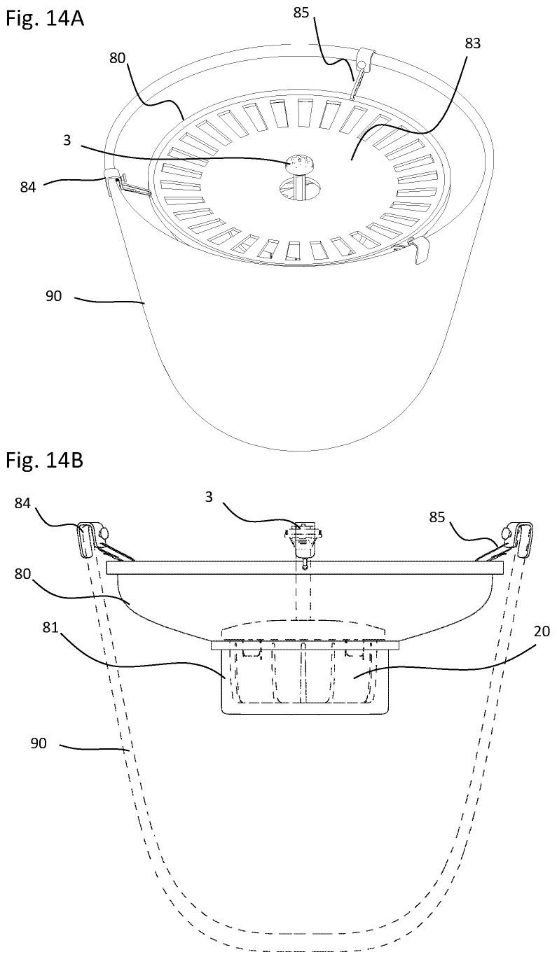

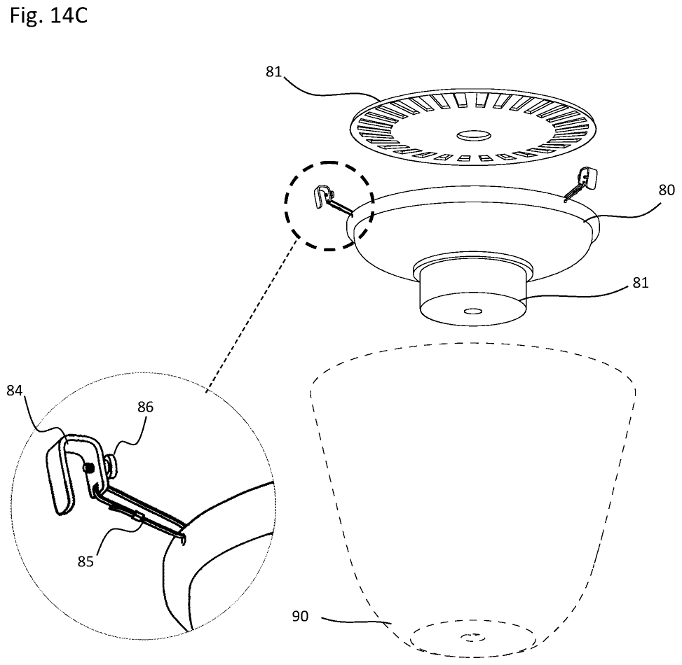

As shown in FIGS. 14A to 14C, another variant of mounting apparatus for mounting the unit 20 comprises a bowl 80 having a recess 81 at the bottom thereof for receiving the unit 20. The bowl 80 and recess 81 comprise a liquid reservoir for holding the liquid to be pumped by the unit 20 and recovering the liquid emitted from the nozzle 3. The bowl 80 is covered by a lid 83 which may support decorative items such as pebbles. The lid 83 includes an aperture 3 through which the nozzle extends and is perforated so as to allow the fluid emitted from the nozzle 3 to drain back into the bowl 80.

The bowl is supported within a decorative pot 90 by a plurality of connectors, such as hangers or hooks 84 which fit over the rim of the pot 90 and are attached to the periphery of the bowl 80 by corresponding loops or ties 85, which are adjustable in length to allow mounting in pots 90 of a range of different diameters. The ties 85 may be cable ties, turnbuckles or other adjustable length connectors.

Each of the hooks 84 includes an adjustable screw 86 for clamping onto the rim of the pot 90; this allows use with pots 90 with rims of different thicknesses.

This arrangement allows the unit 20 to be mounted on the rim of the pot 90, and is adjustable for different diameters and thicknesses of pot 90.

In this variant, the pot 90 does not act as a reservoir for the fluid, but supports and provides a decorative surround for the bowl 80. Alternatively, the bowl 80 may include one or more apertures to allow fluid communication with the interior of the pot 90.

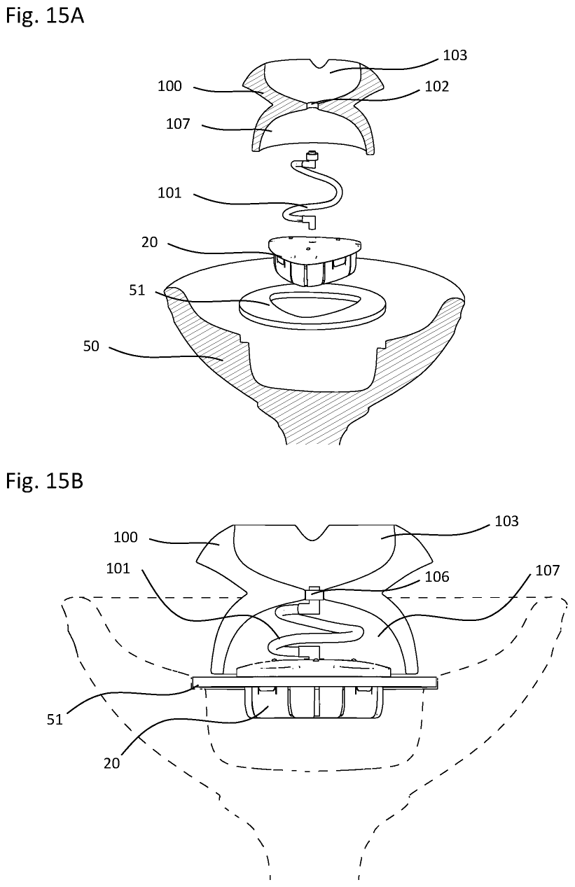

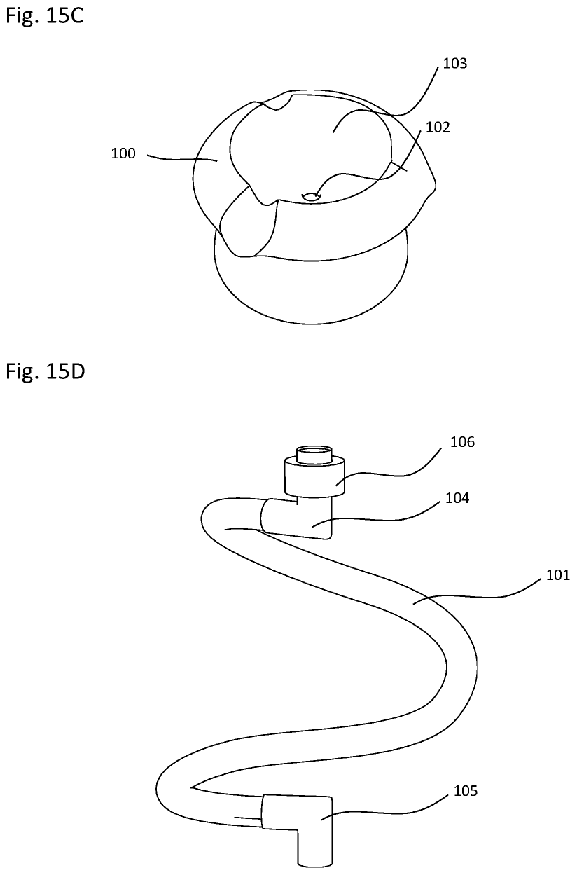

As shown in FIG. 15A to 15D, another mounting apparatus for the unit 20 is similar to that of the embodiment of FIGS. 8A to 8C, but includes a tier portion 100 positioned above the unit 20 (for example, resting on the adapter 51 or on the reservoir 50) and a tube 101 removably connectable at one end to the outlet aperture 30 of the unit 20 and at the other end to an aperture 102 leading to a bowl-shaped upper tier 103 of the tier portion 100. This arrangement provides a cascade effect, with fluid being pumped through the tube 101 to the upper tier 103, from which the fluid cascades into the reservoir 50 and thence is pumped through the unit 20.

As shown in FIG. 15D, the ends of the tube 101 comprise upper and lower right-angled elbow joints 104, 105, so that the tube 101 can fit compactly within a chamber 107 in a lower part of the tier portion 100. A seal 106 is provided around the upper end of the tube 101 so as to seal against the aperture 102.

The arrangement provides a cascade effect using components that can be removably installed above the unit 20, allowing the unit 20 to be removed for charging.

Alternative Charging Arrangements

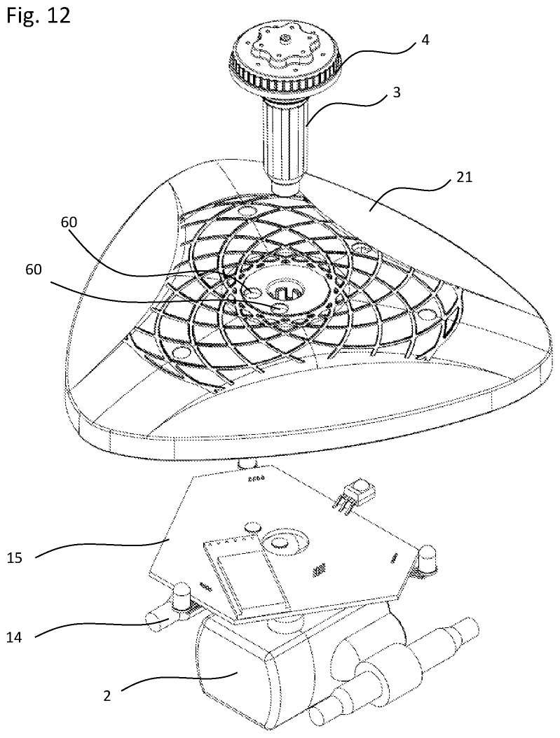

In the third embodiment shown in FIG. 12, the upper portion 21 has electrical contacts 60 for supplying power to the rechargeable power source 1, instead of (or in addition to) the wireless power receiver 6 of the first and second embodiments. The omission of the wireless power receiver 6 allows the unit 20 to be produced more cheaply. With appropriate sealing, the risk of fluid ingress and corrosion may be reduced or avoided. In this embodiment, the electrical contacts 60 are made waterproof, for example by molding into the housing of the upper portion 21. The electrical contacts 60 are preferably made of a corrosion-resistant material, such as of stainless steel.

The electrical contacts 60 may be provided on the upper surface of the upper portion 21, but could alternatively be provided in a surface of the lower portion 22.

Power may be supplied through the electrical contacts 60 by means of a power cable with suitable corresponding contacts 61. For example, the contacts 60, 61 may be held in contact by a magnetic element or elements, to form a magnetic connector.

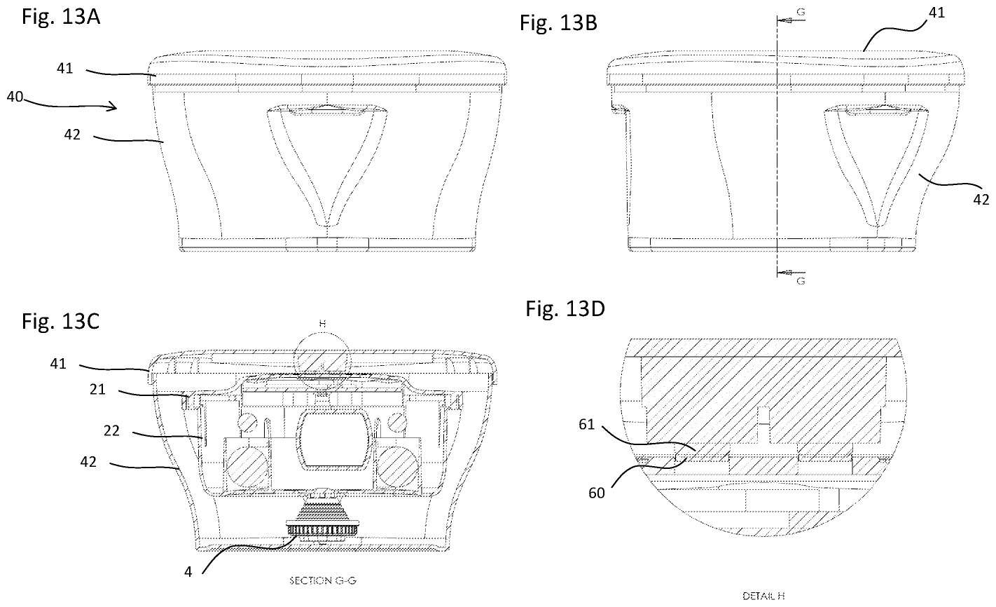

Alternatively, a charging container arrangement may be used, as shown in FIGS. 13A to 13D. This arrangement is similar to that shown in FIGS. 7A to 7D, but the container top 41 carries male contacts 61 instead of the wireless power transmitter 5. The male contacts 61 may be biased into electrical contact with the female contacts 60, for example by spring and/or magnetic couplings. The male contacts 61 are connected via a cable (not shown) to a power supply.

Instead of surface electrical contacts 60, there may be provided a waterproof electrical socket in the unit 20, arranged to connect to a corresponding plug for charging. The plug and socket may be cordless.

Additional Features

Additional advantageous features may be added to any of the above embodiments. For example, the operation of the pump 2 may be controlled by a wireless remote control connected wirelessly to the controller 12, thereby avoiding having to provide an external switch which might be hazardous or unreliable in a wet environment. The controller may detect dry running of the pump 2 and interrupt the power supply to the pump 2 in response to the detection.

One or more audio output devices, such as speakers, may be integrated within the unit 20, and powered by the power source 1. Suitable waterproof audio output devices include piezoelectric speakers. The speaker(s) may comprise one or more transducers acoustically coupled to the upper surface of the upper portion 21.

The audio output device(s) may be connected wirelessly to an audio source, for example via a Bluetooth® connection. The audio source may be integrated with the wireless remote control for example as a smartphone app.

A misting device, such as an ultrasonic misting device, may be integrated within the unit 20, and powered by the power source 1. A motor may be integrated within the unit 20 and may be powered by the power source, for example to move (e.g. rotate) the nozzle 3 or to move another part.

System Components

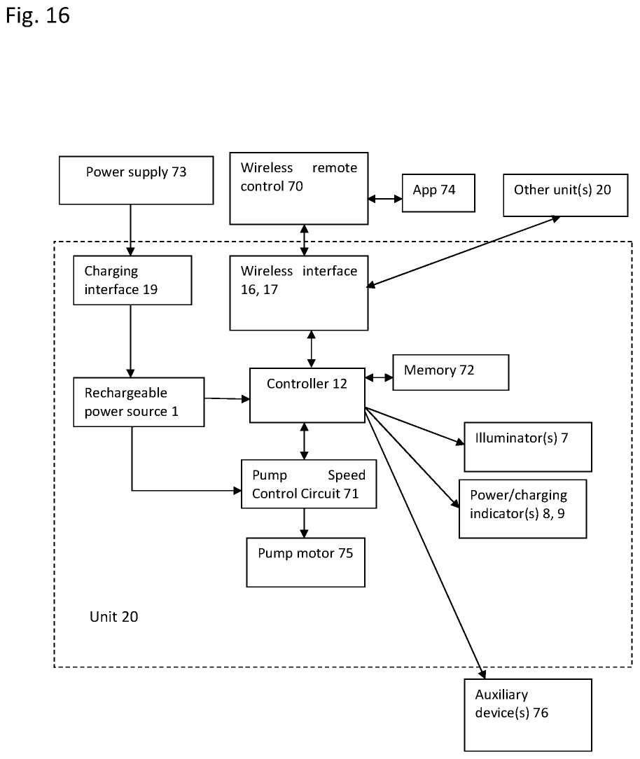

FIG. 16 shows schematically components of a system incorporating the unit 20 of an embodiment, which may be one of the embodiments described above, optionally together with additional features as described herein.

Within the unit 20 there is provided a charging interface 19, such as the wireless power receiver 6 of the first and second embodiments, or the contacts 60 of the third embodiment, for connection to a power supply 73. These provide power to the rechargeable power source(s) 1, for example by means of a charge control circuit. Power from the rechargeable power source(s) 1 is provided to a pump motor 75 of the pump 2, through a pump speed control circuit 71.

A controller 12, such as a microcontroller or microprocessor, controls the switching on and off as well as the speed of the pump motor 75 via a pump speed control circuit 71. Advantageously, the controller 12 may control the speed so as to increase the life of the rechargeable power supply 1. For example, the controller 12 may provide a pulsed operation setting, whereby the speed is varied periodically so as to provide a pulsed effect. This may reduce power consumption by up to 50%, without materially affecting the visual appearance of the water feature. Unit settings may be stored in a memory 72 accessed by the controller 12.

The pump speed control circuit 71 may include a boost circuit for increasing the voltage supplied by the power source 1 to provide a higher voltage to the pump motor 75. For example, the power source may comprise two Li-ion batteries providing 4.2V per cell, or three 1.5V rechargeable batteries, but the output to the pump motor 75 may be boosted to 12V. This allows flexibility in the number of rechargeable batteries and types of motor that may be used. The boost circuit may output a variable DC voltage so as to control the speed of the pump motor. The boost circuit may comprise a buck-boost circuit able to output a variable voltage either lower or higher than the input voltage.

The controller 12 may communicate via a wireless interface, such as Bluetooth and/or Wi-Fi module 16 and/or IR receiver 17, to a wireless remote control 70 such as a mobile device running an app 74, or a dedicated remote control, so as to allow remote control of functions of the device.

To increase the range of wireless communication, an external antenna may be provided for the wireless interface. The external antenna may be molded into the upper portion 21 and/or the nozzle 3.

The controller 12 and/or the remote control 70 may be programmable so as provide functions of the unit 20 at specific times, for specific durations, or in response to triggers such as proximity of a user.

The controller 12 may communicate via a wireless interface with other units 20 so as to coordinate functions between units 20, for example for synchronized operation. The controller 12 of one of the units 20 may be designated as a master controller, for example by remote control 70, and the controllers 12 of other units may be set as slave controllers 12 which are controlled by the master controller.

The controller 12 may connect via a wireless interface, such as a Wi-Fi interface, to a network, for example for remote control or firmware updates over the network.

The controller 12 may also control the light source(s) 7, power indicator 8, charging indicator 9, and/or one or more auxiliary devices 76. The auxiliary device(s) 76 may be integrated within the unit 20 or may be external to the unit 20, and may comprise: one or more motors for driving additional functions such as decorative moving parts; one or more sounds generators for music or sound effects; and one or more ultrasonic misters.

In an alternative arrangement, the unit 20 may be controlled by a user interface provided on the unit 20 itself, rather than by a wireless remote control. For example, a multi-function button (MFB) may be provided on the unit 20, such as on the upper surface of the upper portion 21. This allows the system to be more cost-effective, because there is no need for remote control 70 or the wireless interface 16, 17. Moreover, the system may be more power-efficient because there is no need to power the wireless interface 16, 17 in order to detect input from the remote control 70.

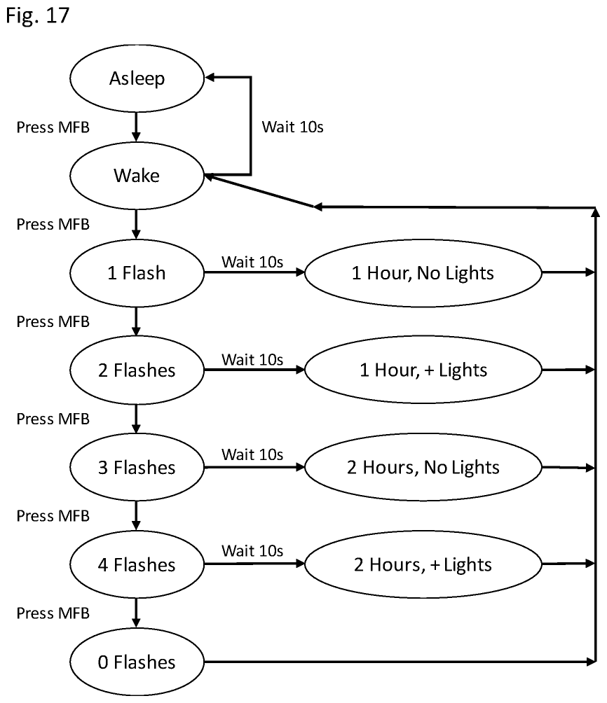

The operation of the unit 20 may be controlled by one or more presses of the MFB, as shown for example in FIG. 17 in which one or more of the light sources 7 flash the number of times indicated to confirm the pressing of the MFB. After an interval such as 10 seconds has elapsed since the last press of the MFB, the unit 20 may adopt a corresponding setting such as running the pump 2 for the number of hours shown, and either setting the light sources 7 on or off during that time.

### Alternative Embodiments

Features from one of the above embodiments may be combined with features of another one of the embodiments, where these are compatible.

The embodiments described above are illustrative of rather than limiting to the present invention. Alternative embodiments apparent on reading the above description may nevertheless fall within the scope of the invention.

What is claimed is:

1. Apparatus for an electrically powered fluid feature, comprising a unit including a housing containing a pump and a rechargeable power source arranged to provide power to the pump for operation of the fluid feature; wherein waterproof electrical contacts for recharging the power source are provided on an external surface of the housing.

2. Apparatus of claim 1, including a magnetic coupling arranged to hold the electrical contacts of the unit in electrical contact with corresponding electrical contacts external to the unit.

3. Apparatus of claim 1, wherein the electrical contacts of the unit are provided in an upper portion of the housing, and wherein the unit further includes a lower housing portion removably attached or attachable to the upper housing portion.

4. Apparatus of claim 3, wherein a controller for controlling operation of the unit is provided within the upper housing portion, and wherein the controller is sealed in one or more compartments within the upper housing portion.

5. Apparatus of claim 4, wherein the electrical contacts of the unit are sealed into the upper housing portion.

6. Apparatus of claim 3, wherein the unit includes a user interface connected to the controller so as to control an operational state of the unit.

7. Apparatus of claim 3, wherein the rechargeable power source comprises one or more rechargeable cells or batteries sealed within one or more power source compartments in the lower housing portion.

8. Apparatus of claim 1, further comprising a fluid reservoir and a support for supporting the unit within the reservoir, wherein the support is removably attachable to the reservoir.

9. Apparatus of claim 8, wherein the fluid reservoir has a drainage hole in the bottom thereof, and the support is mounted to, and seals the drainage hole.

10. Apparatus of claim 8, wherein the support is adjustable so as to adjust the height of the unit within the reservoir.

11. Apparatus of claim 8, wherein the support includes a platform for supporting the unit.

12. Apparatus of claim 11, wherein the platform includes a recessed portion for removably receiving the unit and a horizontal surface surrounding or extending beyond the unit.

13. Apparatus of claim 1, further comprising a fluid reservoir arranged to removably receive the unit, and a support for supporting the fluid reservoir within a container.

14. Apparatus of claim 13, wherein the support comprises a plurality of connectors attachable to a periphery of the container.

15. Apparatus of claim 13, wherein each of connectors has a portion of adjustable length arranged to extend between the fluid reservoir and the periphery of the container.

16. Apparatus of claim 13, wherein the support comprises a bowl having a recess for removably receiving the unit.

17. Apparatus of claim 16, further including a removable lid arranged to allow fluid output by the pump to pass therethrough, the lid being perforated to allow fluid to drain therethrough and thereby return to the pump.

18. Apparatus of claim 1, further comprising a fluid reservoir for removably receiving the unit and an upper tier portion positionable above the fluid reservoir and removably connectable to an output of the pump, such that fluid output by the pump passes into the upper tier portion and thence cascades from the upper tier portion into the fluid reservoir.

19. Apparatus for an electrically powered fluid feature, comprising: a unit including a housing containing a pump and a rechargeable power source arranged to provide power to the pump for operation of the fluid feature; a fluid reservoir arranged to removably receive the unit, and a support for supporting the fluid reservoir within a container, the support comprising a plurality of connectors of adjustable length, attachable to a periphery of the container.

20. Apparatus for an electrically powered fluid feature, comprising: a unit including a housing containing a pump and a rechargeable power source arranged to provide power to the pump for operation of the fluid feature; a fluid reservoir arranged to removably receive the unit, and an upper tier portion positionable above the fluid reservoir and removably connectable to an output of the pump, such that fluid output by the pump passes into the upper tier portion and thence cascades from the upper tier portion into the fluid reservoir.
